(19) United States
(12) Patent Application Publication
(10) Pub. No.: US 2024/0033705 A1
(43) Pub. Date: Feb. 1, 2024

(54) PRESSED SiC FLUIDIC MODULES WITH SURFACE HEAT EXCHANGE CHANNELS

(71) Applicant: CORNING INCORPORATED, CORNINING, NY (US)

(72) Inventors: Alexander Lee Cuno, Sayre, PA (US); Howen Lim, Great Neck, NY (US); Michael Joseph McLaughlin, III, Hagerstown, MD (US); Kenneth Doyle Shaughnessy, Chattanooga, TN (US); James Scott Sutherland, Painted Post, NY (US)

(21) Appl. No.: 18/022,577

(22) PCT Filed: Aug. 27, 2021
(86) PCT No.: PCT/US2021/047899

§ 371 Date: Feb. 22, 2023

Related U.S. Application Data
(60) Provisional application No. 63/072,930, filed on Aug. 31, 2020.

(51) Int. Cl. B01J 19/24

(52) U.S. Cl. CPC B01J 19/249; B01J 2219/00085; B01J 2219/00783; B01J 2219/00813; B01J 2219/00817; B01J 2219/00828; B01J 2219/2464; B01J 2219/00054

(57) ABSTRACT

A flow reactor or flow reactor component includes a base plate, a first fluid module having first and second major surfaces, an internal process fluid passage, and a heat exchange channel in the first major surface, the first major surface stacked on the base plate; a second fluid module having first and second major surfaces, an internal process fluid passage and a heat exchange channel in the first major surface, the first major surface stacked on the second major surface of the first fluid module, optional additional fluid modules of the same configuration as the first and second fluid modules stacked successively on the second fluid module, and a top plate having a heat exchange channel in a bottom major surface thereof with the bottom major surface stacked on an uppermost fluid module of (1) the second fluid module and (2) the optional additional fluid modules.

### CROSS-REFERENCE TO RELATED APPLICATIONS

This application claims the benefit of priority under 35 U.S.C. § 119 of U.S. Provisional Application Ser. No. 63/072,930, filed on Aug. 31, 2020, the content of which is relied upon and incorporated herein by reference in its entirety.

### FIELD

The disclosure relates flow reactors or flow reactor components comprising stacked fluid modules having surface heat exchange channels.

### BACKGROUND

Ceramics generally, and silicon carbide ceramic (SiC) in particular, are desirable material for fluidic modules for flow chemistry production and/or laboratory work. Some ceramics, and SiC in particular, have relatively high thermal conductivity, useful in performing and controlling endothermic or exothermic reactions. Many ceramics have good physical durability and thermal shock resistance, and good chemical corrosion resistance. SiC in particular performs very well on these measures. But these properties, combined with high hardness and abrasiveness, make the economical production of flow reactors, in particular as flow reactors having both long residence time and high heat exchange performance, and/or variable heat exchange performance, somewhat difficult.

### SUMMARY

This disclosure presents, according to aspects thereof, techniques for fabricating pressed ceramic fluid modules (desirably of silicon carbide [SiC] ceramic) with surface heat exchange channel layers. In one or more embodiments, the process may involve first placing a heat exchange channel wax form on the bottom surface of the pressing die. Then SiC powder is poured over the heat exchange channel wax form, a reactant channel wax form is added on top of this first SiC powder layer, and finally a second cover layer of SiC powder is applied over the reactant channel wax form. During pressing the SiC powder and the wax forms compress and maintain their relative positions, and after sintering, an internal reactant channel path and a channel in the surface of the pressed fluidic module are formed. In one or more alternative embodiments, a first layer of SiC powder is first poured into the pressing die, the reactant channel wax form is then be positioned into/over the first layer of SiC powder, a second layer of SiC powder is applied over the reactant channel wax form, and then the heat exchange channel wax form is embedded into the second layer of SiC powder (e.g., by positioning it in the pressing die or by attaching it to the press ram, which embeds it into the second layer of SiC powder). As with the other fabrication embodiment, the SiC powder and wax forms are pressed and sintered to form the fluidic module having the internal reactant channel and the heat exchange channel on the surface of the fluid module.

According to aspects, the heat exchange channel can accept a piece of heat exchange tubing, which can be pressed into the channel and retained in place. According to other aspects, the channel can be enclosed directly by stacking a plate or another module over the channel. Either approach allows multiple fired fluid modules to be stacked together, where the surface heat exchange channels are in close proximity to its own fluid module as well as the fluid module (if any) that is stacked on top of it. This method of use of the stacked modules as a flow reactor or flow reactor component reduces reactor system cost by eliminating separate external metallic heat exchange plates. The approach also reduces cost by reducing the number of external fluid ports and interconnection hardware (including corrosion resistant O-rings) required to assemble a reactor system.

According to aspects, a flow reactor or flow reactor component is provided comprising a base plate having top and bottom major surfaces opposite each other and of planar shape.

In one or more embodiments, the flow reactor or flow reactor component further includes a first fluid module having first and second major surfaces of planar shape on opposite sides thereof and an edge surface extending between the first and second major surfaces. The first fluid module has a process fluid passage extending internally within the first fluid module from an entrance in the first major surface to an exit in the second major surface. The first fluid module also has a heat exchange channel in the first major surface. The first fluid module is stacked on the base plate with the first major surface of the first fluid module stacked on the top major surface of the base plate.

In one or more embodiments, the flow reactor or flow reactor component further includes a second fluid module having first and second major surfaces of planar shape on opposite sides thereof and an edge surface extending between the first and second major surfaces. The second fluid module has a process fluid passage extending internally within the first fluid module from an entrance in the first major surface to an exit in the second major surface. The second fluid module also has a heat exchange channel in the first major surface, and the second fluid module is stacked on the first fluid module with the first major surface of the second fluid module stacked on the second major surface of the first fluid module.

The flow reactor or flow reactor component optionally further includes additional fluid modules of the same configuration as the first and second fluid modules stacked successively in like fashion on the second fluid module. In one or more embodiments, the fluidic modules are stacked so that at least a portion of their major surfaces overlap one another, and where heat exchange channels may be provided in regions of the major surfaces that overlap.

In one or more embodiments, the flow reactor or flow reactor component further includes a top plate having top and bottom major surfaces opposite each other and of planar shape. The top plate has a heat exchange channel in the bottom major surface, and the top plate is stacked on an uppermost fluid module of (1) the second fluid module and (2) the optional additional fluid modules, with the bottom major surface of the top plate stacked on the second major surface of the uppermost fluid module.

The surface heat exchange channels can be implemented on one or both sides of the fluidic modules, and the fluidic modules can include one or more internal reactant channel layers.

The heat transfer performance of the surface heat exchange channels can be tuned by selecting different types of insert tubing, and by adding insulating materials to the surface channel sidewalls and bottom.

In a reactor with multiple fluidic modules, the heat transfer performance of specific modules can be easily enhanced or degraded as needed, even where all heat transfer channels are attached to a common thermal management system. Heat transfer performance can also be enhanced or degraded at specific locations of a single fluidic module by adding insulating materials at specific regions along the path of the surface channel sidewalls and bottom.

The total volume of the reactor system can be reduced by integrating two or more reactant channel layers within the fluidic module, where these reactant fluid channel layers are heated or cooled by heat exchange channels located at the surface of the fluidic module.

Avoiding use of external heat exchange plates allows the total reactor external packaging volume to be reduced, enabling fabricating of more compact reactor systems.

The fabrication process for pressing a single layer fluidic module is extended to fluidic modules with surface heat exchange capability, with no significant change in the fabrication process.

The main process change occurs during pressing, where the only addition is a heat exchange channel mold that is placed on the bottom surface of the pressing die prior to SiC powder filling (or on top of the SiC powder after filling). No additional layers of SiC powder are required and all other processing steps are very similar.

The fabrication process for molds for surface heat exchange channels is identical to the process used to fabricate reactant channel molds.

Reactor system cost is reduced by reducing the need for external heat exchange hardware. If multiple reactant channel layers are employed, the approach reduces reactor system cost by reducing the number of separately connected fluid modules required for a reactor of the same volume, reducing hardware and interconnection cost by eliminating the number of external fluid ports, interconnection hardware, and corrosion-resistant O-rings required to assemble a reactor system.

Additional features and advantages will be set forth in the detailed description which follows, and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the disclosure and the appended claims.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a diagrammatic cross-sectional elevation view of an embodiment of a flow reactor or flow reactor component according to aspects of the present disclosure;

FIG. 2 is a diagrammatic cross-sectional elevation view of another embodiment of a flow reactor or flow reactor component according to aspects of the present disclosure;

FIG. 3 is a diagrammatic cross-sectional elevation view of yet another embodiment of a flow reactor or flow reactor component according to aspects of the present disclosure;

FIGS. 4A and 4B are a plan view of some elements of an embodiment of a flow reactor or flow reactor component and a partial cross-sectional view of an overhang region of the heat exchange channel, according to aspects of the present disclosure;

FIG. 5 is a view of an embodiment of a top major surface of an embodiment of a base plate of a flow reactor or flow reactor component according to aspects of the present disclosure;

FIG. 6 is a view of an embodiment of a bottom major surface of an embodiment of a top plate of a flow reactor or flow reactor component according to aspects of the present disclosure;

FIG. 7 is an exploded perspective drawing of some elements of an embodiment of a flow reactor or flow reactor component according to aspects of the present disclosure;

FIG. 8 is a partially exploded perspective drawing of some additional elements of an embodiment of a flow reactor or flow reactor component according to aspects of the present disclosure, in which the elements shown in FIG. 7 are already assembled;

FIG. 9 is a partially exploded perspective drawing of some additional elements of an embodiment of a flow reactor or flow reactor component according to aspects of the present disclosure, in which the elements shown in FIG. 8 are already assembled;

FIG. 10 is a partially exploded perspective drawing of some additional elements of an embodiment of a flow reactor or flow reactor component according to aspects of the present disclosure, in which the elements shown in FIG. 9 are already assembled;

FIG. 11 is a partially exploded perspective drawing of some additional elements of an embodiment of a flow reactor or flow reactor component according to aspects of the present disclosure, in which the elements shown in FIG. 10 are already assembled;

FIG. 12 is a partially exploded perspective drawing of some additional elements of an embodiment of a flow reactor or flow reactor component according to aspects of the present disclosure, in which the elements shown in FIG. 11 are already assembled;

FIG. 13 is a perspective drawing of an embodiment of a flow reactor or flow reactor component according to aspects of the present disclosure, in which the elements shown in FIG. 12 are assembled;

FIG. 14 is a graph of relative heat exchange performance obtainable with an embodiment of a flow reactor or flow reactor component according to aspects of the present disclosure, such as by using various tube materials;

FIG. 15 is a flow chart showing some embodiments of a method for producing a fluidic module of the present disclosure;

FIG. 16 is a step-wise series of cross-sectional representations of some embodiments of the method(s) described in FIG. 15;

FIG. 17 is a graph illustrating compression release curves useful in practicing the methods of the present disclosure;

FIG. 18 is a cross-sectional representation of an embodiment of an apparatus for performing the pressing step and/or the demolding step of the method of FIG. 15;

FIG. 19 is a flow chart of an embodiment of a process by which demolding can be performed with pressure applied through a fluid-tight bag enclosing a green state powder pressed ceramic body;

FIG. 20 is a cross-sectional representation of an embodiment of an apparatus for use in performing the pressing step and/or the demolding step of the method of FIG. 15 and/or the demolding of FIG. 19;

FIGS. 21 and 22 are cross-sectional representations of forms the green state powder pressed ceramic body and mold material may take during and after demolding such as by the process according to FIG. 19;

FIG. 23 is a cross section of an additional or alternative embodiment of elements of the apparatus of FIG. 20;

FIG. 24 is a cross section of another additional or alternative embodiment of elements of the apparatus of FIG. 20;

FIG. 25 is a cross section of yet another additional or alternative embodiment of elements of the apparatus of FIG. 20;

FIG. 26 is a cross section of still another additional or alternative embodiment of elements of the apparatus of FIG. 20; and

FIG. 27 is a cross section of still one more additional or alternative embodiment of elements of the apparatus of FIG. 20.

### DETAILED DESCRIPTION OF THE PREFERRED EMBODIMENTS

Additional features and advantages will be set forth in the detailed description which follows and will be apparent to those skilled in the art from the description or recognized by practicing the embodiments as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, a “tortuous” passage refers to a passage having no line of sight directly through the passage and with the central path of the passage tracing more than one radius of curvature. Typical machining-based forming techniques are generally inadequate to form such a passage.

As used herein a “monolithic” ceramic or silicon carbide ceramic structure of course does not imply zero inhomogeneities in the ceramic structure at all scales. Monolithic, as the term is defined herein, refers to a ceramic or silicon carbide structure, with internal cavities such as a tortuous passage extending therethrough, in which no inhomogeneities of the ceramic structure are present of sufficient size to extend from an external surface of the fluidic module to a surface of the tortuous passage.

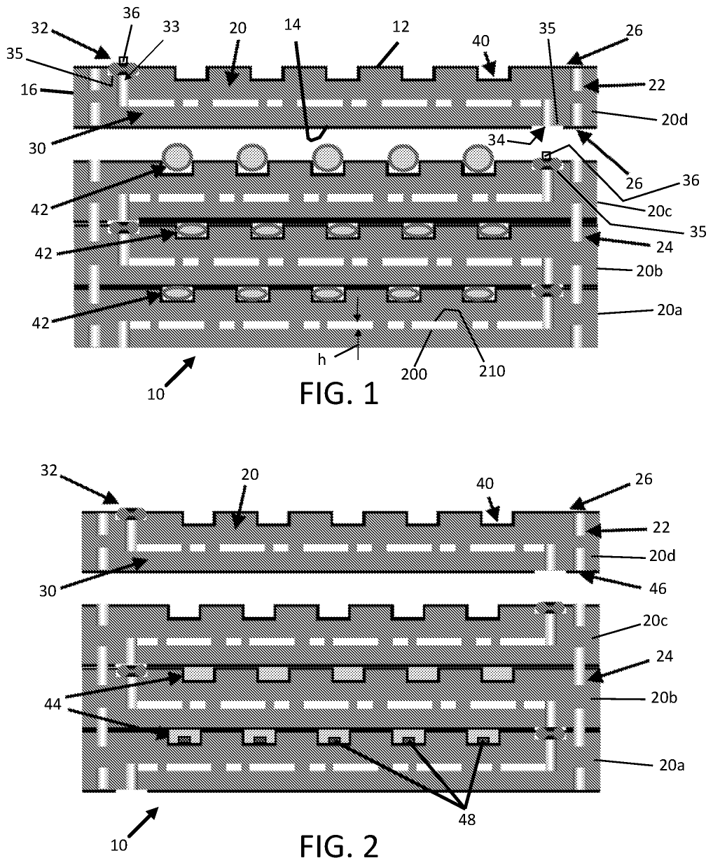

FIG. 1 depicts an embodiment of a flow reactor 10 or flow reactor component 10. As can be seen in FIG. 1, the flow reactor 10 includes a stack of a plurality of fluid modules 20. FIG. 1 depicts a stack of four fluid modules 20, including a first fluid module 20a, a second fluid module 20b, a third fluid module 20c, and a fourth fluid module 20d. In embodiments the flow reactor 10 comprises at least two fluid modules 20. The number of fluid modules 20 that may be included in the flow reactor 10 is not particularly limited, but in one or more embodiments, the number of fluid modules 20 may be up to ten, up to fifteen, up to twenty, or even more depending on the requirements of the application. For larger stacks, provision may be needed for uniform distribution of heat exchange fluid. Advantageously, the embodiments of the fluidic modules 20 disclosed herein allow for enhanced customizability of heat exchange fluid delivery.

Various embodiments of fluid modules 20 are described herein. The stack of fluid modules 20 may contain only fluid modules 20 of the same type, or the stack of fluid modules 20 may contain any combination of the various embodiments of the fluid modules 20 described herein. Further, while fluid modules 20 having the same size (in particular same parallel face area) are depicted, each fluid module 20 may be of a different size (in particular have a different parallel face area). For example, a first fluid module 20a may be larger or smaller than a second stacked fluid module 20b so that a portion of the facial area of the larger fluid module 20a extends beyond the facial area of the smaller fluid module 20b. In this way, the extended region can be used for providing an intermediate fluid inlet to a fluid module 20 of the flow reactor 10 stack.

A first embodiment of the fluid module 20 is shown in FIG. 1. The fluid module 20 has a first major surface 12 and a second major surfaces 14. The first major surface 12 is opposite to the second major surface 14, and the first major surface 12 is connected to the second major surface 14 by an edge surface 16 that extends between the first major surface 12 and the second major surface 14. In one or more embodiments, the first major surface 12 and the second major surface 14 define a generally planar shape of the fluid module 20.

In one or more embodiments, the fluid modules 20 include alignment holes 22 formed in the first major surface 12 and in the second major surface 14. As can be seen in FIG. 1, the alignment holes 22 formed into the first major surface 12 are in registration with the alignment holes 22 formed into the second major surface 14. The alignment holes 22 are configured to receive alignment pins 24. In a stack of fluid modules 20, the alignment pins 24 are inserted into the alignment holes 22 in the first major surface 12 of a first fluid module 20a. The alignment pins 24 will extend above the first major surface 12 of the first module mate with the alignment holes 22 formed in the second major surface 14 of the second module 20b. In this way, the fluid modules 20 can be aligned and stacked. Advantageously, the alignment feature of the alignment holes 22 and alignment pins 24 allows fluid carrying features (described in more detail below) of the fluid modules 20 to be arranged and connected more quickly.

Each fluid module 20 includes a process fluid passage 30 extending internally within the fluid module. Fluid enters the process fluid passage 30 through an entrance port 33 in the first major surface 12, and fluid exits the process fluid passage 30 through an exit port 34 in the second major surface 14. The use of “entrance” and “exit” with respect to the ports 33, 34 is not meant to imply that fluid can only flow in one direction within the process fluid passage 30. Indeed, flow through the process fluid passage 30 can flow in both directions, and reference is made to “entrance” and “exit” ports 33, 34 for the purpose of illustration only. Notwithstanding, in certain embodiments, the process fluid passage 30 may be structured in such a way to provide enhanced mixing when fluid flows in a certain direction through the process fluid passage 30. In one or more embodiments, the process fluid passage 30 defines a tortuous path between the entrance port 33 and the exit port 34.

Within a stack of fluid modules 20, the exit port 34 of one fluid module 20 is aligned with the entrance port 33 of an adjacent fluid module 20 such that fluid flows from one fluid module 20 to the next in the stack. To reduce the possibility of leakage when fluid flows between the fluid modules 20, an O-ring 32 is provided between the exit port 34 and the entrance port 33 of adjacent fluid modules 20. In embodiments, a gland 35 is formed around at least one of the entrance port 33 or the exit port 34. The O-ring 32 is positioned in the gland 35 and is compressed between adjacent fluid modules 20. In one or more embodiments, a stem 36 may be inserted in O-ring 32 and may abut the gland 35 to facilitate fluid communication between the exit port 34 of one fluid module 20 and the entrance port 33 of an adjacent fluid module 20. In such embodiments, the stem 36 may be a short piece of, e.g., polytetrafluoroethylene (PTFE) tubing that extends between the first major surface 12 of one fluid module 20 and the second major surface 14 of another fluid module 20. In embodiments in which the stem 36 is included, the stem 36 may serve as an additional alignment feature, or the stem 36 may be used instead of the alignment features, such as the alignment holes 22 and alignment pins 24. The process fluid passage 30 may be used as a reactant flow path in which one or more reactants are reacted over the course of the process fluid passage 30 extending through the stack of fluid modules 20.

The temperature of the fluid in the process fluid passage 30 can be controlled using a heat exchange channel 40 formed into or provided on the first major surface 12 of the fluid module 20. In the embodiment shown in FIG. 1, the heat exchange channel is formed in the first major surface 12 of the fluid module 20. For example, in embodiments, the heat exchange channel 40 traces a serpentine depression into the first major surface 12. In embodiments, the heat exchange channel 40 does not carry fluid but instead carries tubing 42 that carries fluid for exchanging heat with the process fluid passage 30.

By using a tubing 42 in the heat exchange channel 40, the heat exchange characteristics can be tailored for different applications. For example, the material of the tubing 42 can be selected to provide higher or lower heat conductivity. In embodiments, the tubing 42 is made from a plastic, metal, ceramic, or glass material. For example, suitable materials for the tubing 42 include rubber, polyvinyl chloride (PVC), polyethylene, PTFE, copper, aluminum, glass, or stainless steel, among others. Further, in embodiments, a thermal paste is provided in the heat exchange channel 40 to fill in any gaps between the tubing 42 and the heat exchange channel 40, which enhances the thermal conductivity between the fluid module 20 and the tubing 42.

In one or more embodiments in which the tube is compressible, the tubing 42 has a diameter greater than the depth of the depression of the heat exchange channel 40. In this way, when the fluid modules 20 are stacked over each other, the tubing 42 is compressed in the heat exchange channel 40 to increase the surface area of the tubing 42 in contact with the floor and sidewalls of the heat exchange channel 40. Compressed tubing 42 can be seen between the first and second fluid modules 20a, 20b and between the second and third modules 20b, 20c. The uncompressed tubing 42 can be seen in the heat exchange channel 40 of the third fluid module 20c.

In embodiments, the thermal conductivity between the process fluid passage 30 and the heat exchange channel 40 is adjusted by providing a coating 26 over one or both of the first major surface 12 and the second major surface 14. In embodiments, the coating 26 is an insulating coating comprised of silicone, rubber, polymer foam, PTFE, polyimide (e.g., Kapton® available from DuPont de Nemours, Inc., Wilmington, DE), or an insulating woven fabric or sheet, such as silicone, rubber, fiberglass, or aramid (e.g., Kevlar® available from DuPont De Nemours, Inc.). Alternatively, the coating may be selected to enhance lateral thermal conductivity, such as a woven fabric or sheet made of copper, stainless steel, brass, or carbon fiber.

FIG. 2 depicts another embodiment of a flow reactor 10 or flow reactor component 10 in which heat exchange fluid flows through the heat exchange channels 40. The fluid modules 20 are substantially the same as the fluid modules 20 shown in FIG. 1. However, in the embodiment depicted in FIG. 2, the heat exchange channels 40 do not include tubing 42, and instead, the heat exchange fluid flows through the heat exchange channels 40 themselves. In such embodiments, the first major surface 12 may still include a coating 26 that extends over the heat exchange channels 40, and in certain embodiments, a sealing coating 46 is provided on the second major surface 14 to seal the fluid modules 20 against each other and prevent leakage from the heat exchange channels 40. In such embodiments, the sealing coating 46 may be comprised of silicone, rubber, PTFE, or any other leak-free gasket material. In this way, the first major surface 12 of a first fluid module 20a and the second major surface 14 of a second fluid module 20b combine to form coated enclosed heat exchange channels 44. In embodiments, the heat exchange channels 40 include raised flow diverters 48 (as shown in fluid module 20a) that introduce turbulence to the flowing heat exchange fluid, which may enhance heat transfer.

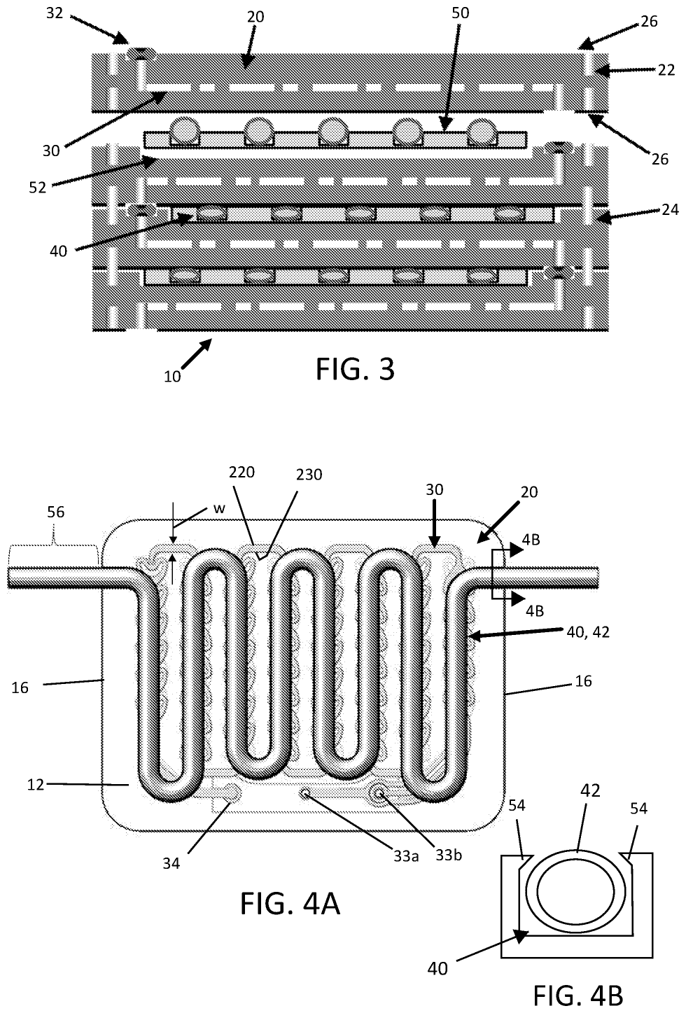

FIG. 3 depicts another embodiment of a flow reactor 10 or flow reactor component 10 in which the fluid modules 20 include a carrier 50 contained in a recess 52 of the first major surface 12. The carrier 50 defines a heat exchange channel 40. Advantageously, the carrier can be fabricated from a relatively inexpensive material, such as plastic, using, e.g., injection molding or 3D-printing. In embodiments, the carrier 50 is secured to the recess 52 using an adhesive material, and in other embodiments, the carrier 50 is allowed to float within the recess 52 and is trapped between adjacent fluid modules 20. In one or more embodiments, the carrier 50 is fabricated from a material that has a thermal conductivity matching the requirements of the reactor system. Advantageously, the recess 52 is relatively easy to form using the processes described below, such as the lost wax process.

FIG. 4A depicts a plan view of the first major surface 12 of a fluid module 20 with the process fluid channel 30 shown in phantom. As can be seen in FIG. 4A, the heat exchange channel 40 holds a tubing 42, and the heat exchange channel 40 traces a serpentine path across the first major surface 12. The serpentine path of the heat exchange channel 40 complements the serpentine path of the process fluid channel 30. In embodiments, the process fluid channel 30 is a tortuous path defined by a series of heart-shaped flow chambers having a flow diverter element disposed within each chamber. Other configurations of the process fluid channel 30 are also possible. Further, in one or more embodiments, the process fluid channel 30 includes a first entrance port 33a, a second entrance port 33b, and an exit port 34. In embodiments, a first fluid may be introduced to the process fluid channel 30 through the first entrance port 33a, and a second fluid may be introduced to the process fluid channel 30 through the second entrance port 33b. The first fluid and the second fluid can then be reacted in the process fluid channel 30, and the at least partially reacted mixture of fluids exits through the exit port 34, where it can flow into an entrance port 33 of an adjacent fluid module 20. Further, in one or more embodiments, such as the embodiment of FIG. 4B, the surface opening of the heat exchange channel 40 is narrower than the maximum width of the heat exchange channel 42 so as to define an overhang region 54, which helps to retain the tubing 42 in the heat exchange channel 40. In embodiments with or without the overhang region 54, the tubing 42 can extend or overhang beyond the edge 16 of the fluid module 20. In this way, a portion of the tubing 42 can be positioned outside of the boundary of the fluid module 20 in an interface region 56 (FIG. 4A) so as to provide connections to a fluid source and/or to extend the tubing 42 to adjacent fluid modules 20.

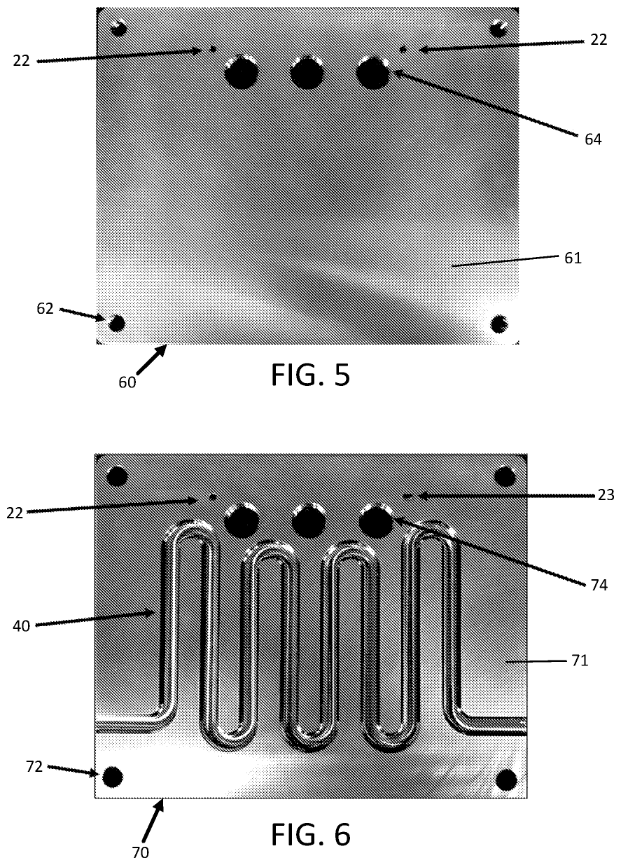

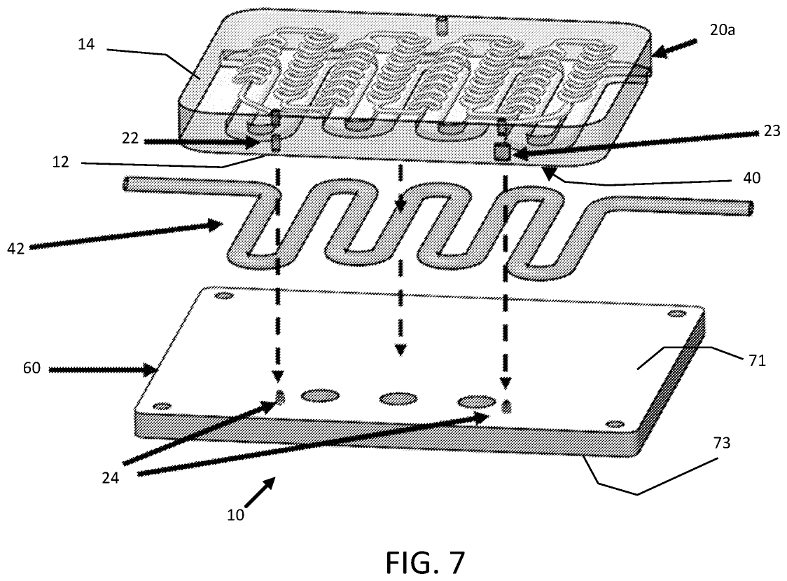

In one or more embodiments, the stack of fluid modules 20 is held together by a base plate 60 and a top plate 70 as depicted in FIGS. 5 and 6. Referring first to FIG. 5, the base plate 60 is depicted. The base plate 60 includes a first major surface 61 and a second major surface 63 (depicted in FIG. 7) that opposes the first major surface 61. The base plate 60 includes one or more through holes 62 that facilitate assembly of the base plate 60 with the stack of fluid modules 20 and with the top plate 70. In embodiments, the through holes 62 may be threaded. In one or more embodiments, the number of through holes 62 corresponds to the number of corners in the base plate 60. Thus, for example, the number of through holes 62 may be four in embodiments. Further, the base plate 60 includes threaded ports 64 to which fluid connectors can be attached to provide fluid flow to the entrance and exit ports of the fluid modules. Additionally, the base plate 60 includes alignment holes 22 to facilitate assembly of a first fluid module 20a with the base plate 60 (as shown in FIG. 7).

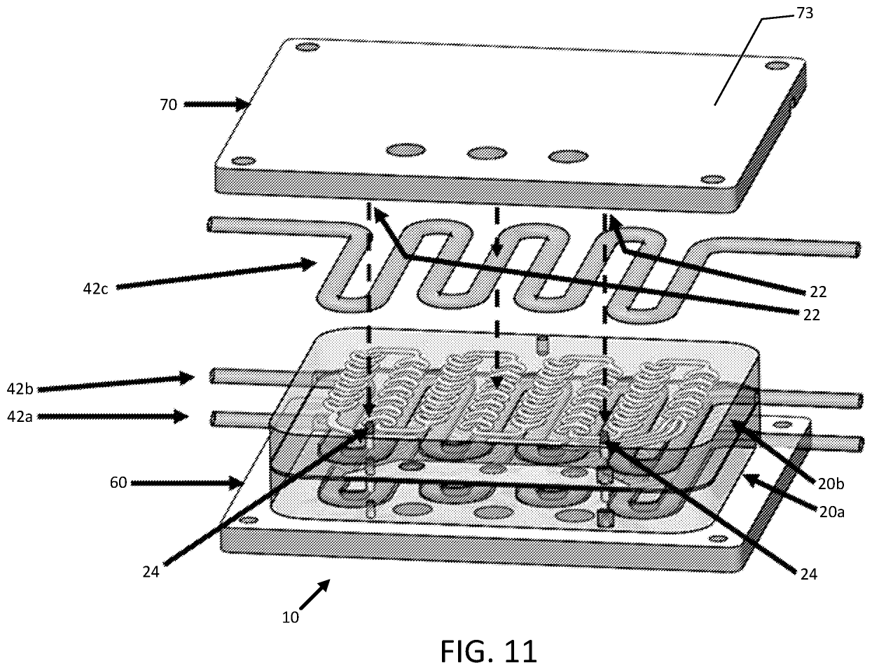

Referring now to FIG. 6, the top plate 70 is depicted. The top plate 70 includes a first major surface 71 and a second major surface 73 (shown in FIG. 11). The top plate 70 includes a heat exchange channel 40 formed in the first major surface 71. Further, the top plate includes one or more through holes 72 that facilitate assembly of the top plate 70 with the base plate 60 and the stack of fluid modules 20. In embodiments, the through holes 72 in the top plate are not threaded if the through holes 62 of the base plate 60 are threaded. Further, in embodiments, the number of through holes 72 in the top plate 70 corresponds to the number of through holes 62 in the base plate 60. Additionally, in embodiments, the top plate 70 may include threaded ports 74 to which fluid connectors can be connected to provide flow to the entrance and exit ports of the fluid modules. Further, in embodiments, the top plate 70 includes at least one alignment hole 22 and may also include an alignment slot 23 to facilitate assembly of the uppermost fluid module 20 with the top plate 70.

Having described the components of the flow reactor 10, FIGS. 7-13 depict an embodiment of a method for assembling the flow reactor 10. Referring first to FIG. 7, alignment pins 24 are inserted into alignment holes 22 of the base plate 60. A first fluid module 20a is arranged over the base plate 60 with the heat exchange channel 40 oriented towards the base plate 60. If included, the tubing 42 is positioned in the heat exchange channel 40 so that the tubing 42 is contained between the first fluid module 20a and the base plate 60. The alignment holes 22 in the first fluid module 20a are aligned with the alignment pins 24 in the base plate 60, and the first fluid module 20a is assembled with the base plate 60. As shown in FIG. 7, an alignment slot 23 is formed in the first major surface 12 of the first fluid module 20a. The alignment slot 23 allows for easier alignment of first module 20a with the alignment pin 24, accounting for any variation in position related to the fabrication of the first fluid module 20a.

In embodiments, the fluid module 20a may instead be assembled with the heat exchange channel 40 facing away from the base plate 60 such that the second major surface 14 contacts the first major surface 61 of the base plate 60. When assembled in this fashion, it may be easier to maintain the tubing 42 in the heat exchange channel 40. In either case, a thin spacer pad (not shown) may be inserted between the fluid module 20a and the base plate 60 to prevent damage to the components as they are stacked and assembled.

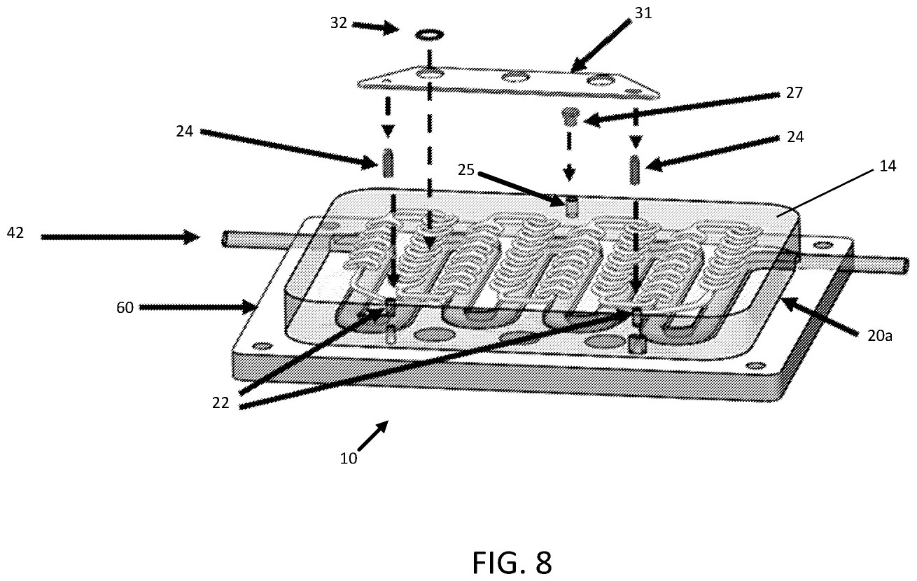

As shown in FIG. 8, alignment pins 24 are inserted into the alignment holes 22 of the upward facing surface (either the first major surface 12 or the second major surface 14) of the first fluid module 20a. Further, O-rings 32 are placed over the port or ports through which fluid flows. In the embodiment depicted, fluid is configured to flow through the exit port 34 on the second major surface 14. As mentioned above, the O-ring 32 may be placed in a gland formed in the second major surface 14. However, in other embodiments, such as the embodiment depicted in FIG. 8, an O-ring frame 31 is provided to position the O-ring 32 on the second major surface 14. Advantageously, the O-ring frame 31 includes through holes that align with the alignment pins 24, which holds the O-ring frame 31 in place over the relevant ports. Because the O-ring frame 31 has a thickness, a spacer pin 27, having a pin head with substantially the same thickness as the O-ring frame 31, may be inserted into a spacer pin hole 25 formed in the second major surface 14 to maintain each fluid module 20 parallel to each other during stacking.

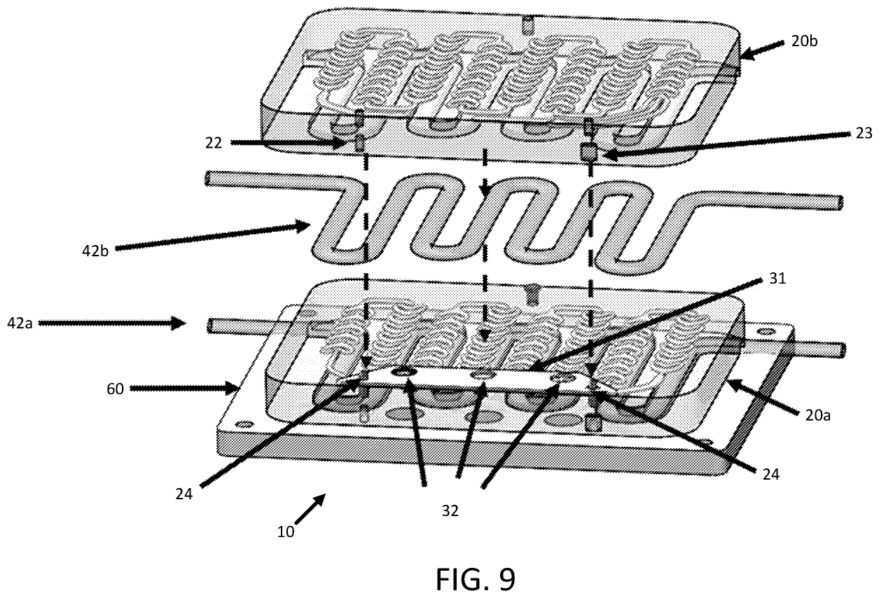

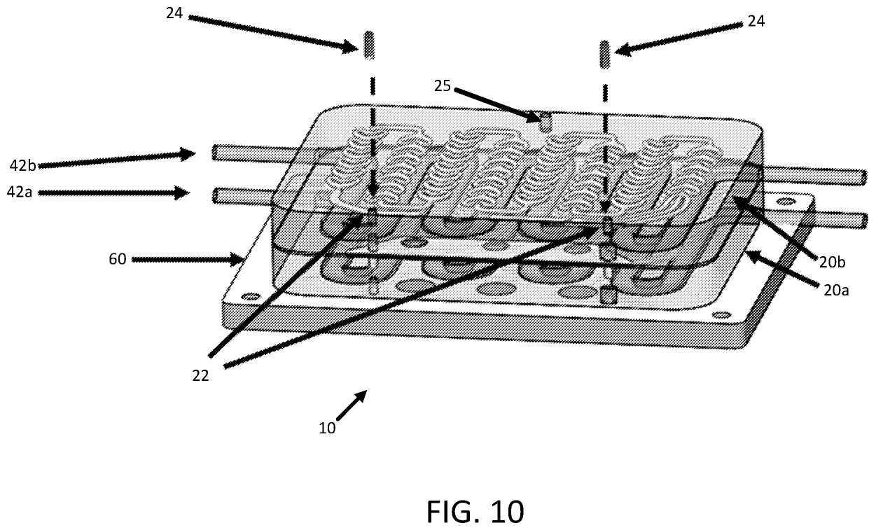

As shown in FIG. 9, a second fluid module 20b is stacked with the first fluid module 20a. The second fluid module 20b is arranged in the same way as the first fluid module 20a. That is, if the heat exchange channel 40 of the first fluid module 20a faces the base plate 60, then the heat exchange channel 40 of the second fluid module 20b will also face the base plate 60. In such a configuration, the tubing 42 (if utilized) will be positioned between the first fluid module 20a and the second module 20b. The alignment holes 22 and/or alignment slot 23 are aligned with the alignment pins 24 extending from the first fluid module 20a, and the second fluid module 20b is stacked with the first fluid module 20a.

As shown in FIG. 10, alignment pins 24 are placed in the alignment holes 22 of the second fluid module 20b to prepare it for the reception of another fluid module 20 or the top plate 70. In this regard, the sequence of stacking can continue for a desired number of fluid modules 20. When the desired number is reached, then the top plate 70 assembled with the stack of fluid modules 20 and the base plate 60 as shown in FIG. 11. In the embodiment depicted, the top plate 70 is assembled over the second fluid module 20b. As discussed above, the top plate 70 has a heat exchange channel 40 formed therein, and thus, a tubing 42 can be accommodated between the second fluid module 20b and the top plate 70. The alignment hole 22 and alignment slot 23 of the top plate 70 (shown in FIG. 6) are arranged over the alignment pins 24 extending from the second fluid module 20b, and the top plate 70 is stacked and assembled with the second fluid module 20b.

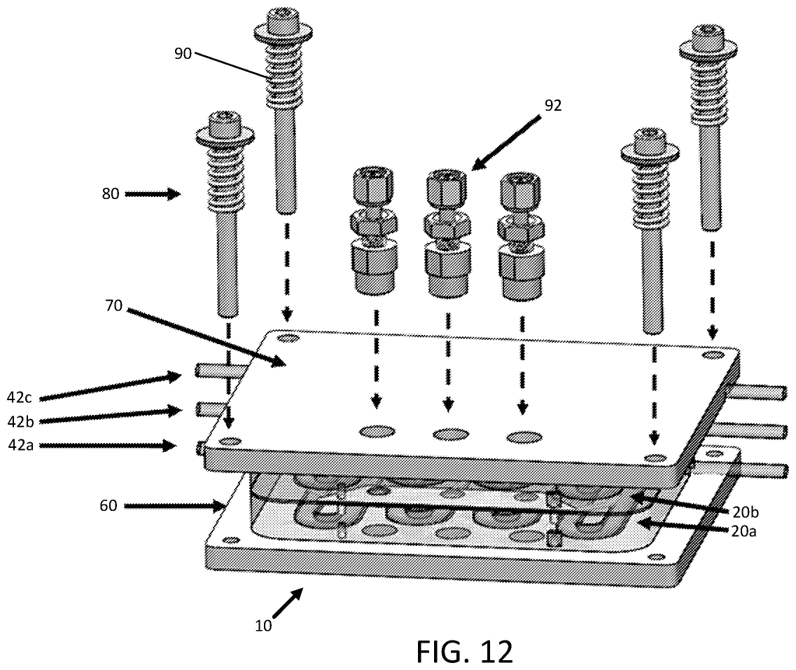

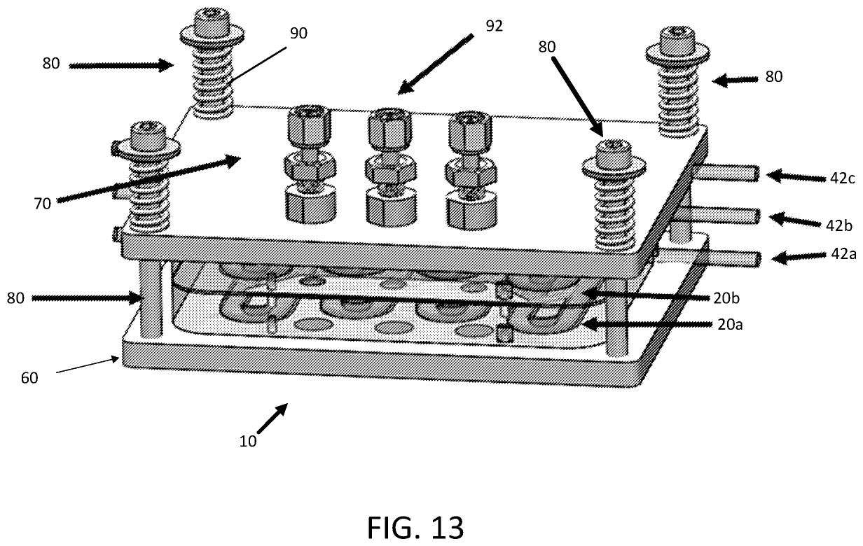

In order to secure the base plate 60, first fluid module 60a, second fluid module 60b, and top plate 70 together as shown in FIG. 12, a plurality of bolts 80 are inserted into the respective through holes 62, 72 of the base plate 60 and the top plate 70. As can be seen in FIG. 12, the base plate 60 and the top plate 70 have a greater area than the area of the first and second fluid modules 20a, 20b. Thus, the base plate 60 and the top plate 70 define a border around the first and second fluid modules 20a, 20b, and the through holes 62, 72 are disposed within the border. In one or more embodiments, the bolts 80 are inserted into the through holes 72 of the top plate 70 and threaded into the through holes 62 of the base plate 60, compressing the first and second fluid modules 20a, 20b therebetween. In other embodiments, the bolts 80 are not threaded into the through holes 62 of the base plate 60 and are instead secured on the second major surface 63 of the base plate 60 with nuts. In one or more embodiments, the bolts 80 are provided with springs 90 that are positioned around the shaft of the bolt 80 and between the head of the bolt and the second major surface 73 of the top plate 70. The springs 90 provide compression of the fluid modules 20a, 20b, and in embodiments using tubes 42, the compressive force flattens the tubes 42 to create greater surface contact with the heat exchange channels 40 of the fluid modules 20a, 20b. Further, as shown in FIG. 12, fluid connectors 92 are provided in threaded ports 74 of the top plate 70. FIG. 13 depicts the assembled flow reactor 10.

Heat transfer performance provided by the heat exchange channel 40 was considered for a single fluid module 20 sandwiched between a base plate 60 and a top plate 70. The heat exchange channel 40 was provided with tubing 42 on each side of the fluid module 20. In particular, tubing 42 was provided in the heat exchange channel 40 of the top plate 70 and, to simulate the performance of the heat exchange channel 40 of the fluid module 20, tubing 42 was taped in a serpentine pattern to a surface of a conventional fluid module opposing the top plate 70 and facing the base plate 60. The inventors believe that thermal performance would be further improved through the use of a heat exchange channel 40 formed into the surface of the fluid module 20 because of the increased contact between the tubing 42 and the fluid module 20, but the experimental setup was believed to provide a rough estimate of the expected heat transfer performance of the presently disclosed fluid module 20.

In the heat transfer performance experiment, heated water was pumped through process fluid channel 30 of the fluid module at a rate of 100 mL/min. Further, cool water was pumped through the tubing 42 provided in the heat exchange channel 40 of the top plate 70 and through the serpentine tubing provided on the opposing side of the fluid module at a rate of 1 L/min. The water temperatures were measured at the process fluid passage entrance and exit ports and at the heat exchange channel inlets and outlets. A temperature drop of 36° C. was measured for the reactant fluidic channel inlet vs. outlet temperature. This temperature drop was compared to the process fluid passage temperature drop (entrance port—exit port temperature) was measured using different tube materials: rubber tubing (HE1), PVC tubing (HE2), copper tubing (3.175 mm OD and 6.35 mm OD) (HE3 and HE4, respectively), and copper tubing (6.35 OD mm) with thermal paste (HE5).

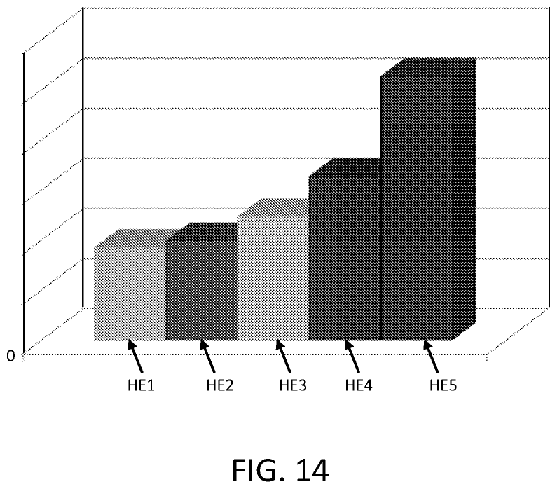

FIG. 14 depicts a graph of the thermal performance of each tubing material. As shown in the graph, the rubber tubing (HE1) provided the lowest heat transfer with a temperature difference of about 7.5° C. The PVC tubing (HE2) provided a temperature difference of about 8.5° C. The copper tubing having an outer diameter of 3.175 mm (HE3) provided a temperature difference of about 11° C., and the copper tubing having an outer diameter of 6.35 mm (HE4) provided a temperature difference of about 15° C. Finally, the copper tubing (6.35 mm OD) used with thermal paste (HE5) provided the highest thermal transfer with a temperature difference of 25° C. These examples demonstrate that the thermal performance of the fluid module 20 can be manipulated to provide higher or lower heat transfer as may be required for various applications.

In one or more embodiments, the fluid modules 20 are comprised of a ceramic material. In particular embodiments, the fluid modules 20 are comprised of silicon carbide (SiC). For silicon carbide embodiments, the interior surface of the process fluid passage 30 desirably has a surface roughness in the range of from 0.1 to 80 μm Ra, or 0.1 to 50, 0.1 to 40, 0.1 to 30, 0.1 to 20, 0.1 to 10, 0.1 to 5, or even 0.1 to 1 μm Ra, lower than silicon carbide fluidic modules have previously been able to achieve.

According to further aspects for silicon carbide embodiments, the body of the fluid module 20 (i.e., the solid portions of the module 20, excluding void regions such as the alignment holes 22, alignment slots 23, process fluid passage 30, heat exchange channel 40, etc.) has a density of at least 95% of a theoretical maximum density of silicon carbide, or even of at least 96, 97, 98, or 99% of theoretical maximum density.

According to further aspects of silicon carbide embodiments, the body of the fluid module 20 has an open porosity of less than 1%, or even of less than 0.5%, 0.4%, 0.2% or 0.1%.

According to still further aspects of embodiments, the body of the fluid module 20 has an internal pressure resistance under pressurized water testing of at least 50 Bar, or even at least 100 Bar, or 150 Bar.

The process fluid passage 30, according to embodiments, comprises a floor 200 and a ceiling 210 separated by a height h (as shown in FIG. 1) and two opposing sidewalls 220, 230 (as shown in FIG. 4A) joining the floor 200 and the ceiling 210. The sidewalls 220, 230 are separated by a width w (FIG. 4A) measured perpendicular to the height h and the direction along the process fluid passage 30 (corresponding to the predominant flow direction when in use). Further, width w is measured at a position corresponding to one-half of the height h. According to embodiments, the height h of the process fluid passage is in the range of from 0.1 to 20 mm, or from 0.2 to 15, or 0.3 to 12 mm.

According to embodiments, the interior surface of the process fluid passage 30 where the sidewalls 220, 230 meet the floor 200 has a radius of curvature of greater than or equal to 0.1 mm, or greater than or equal to 0.3, or even 0.6 mm.

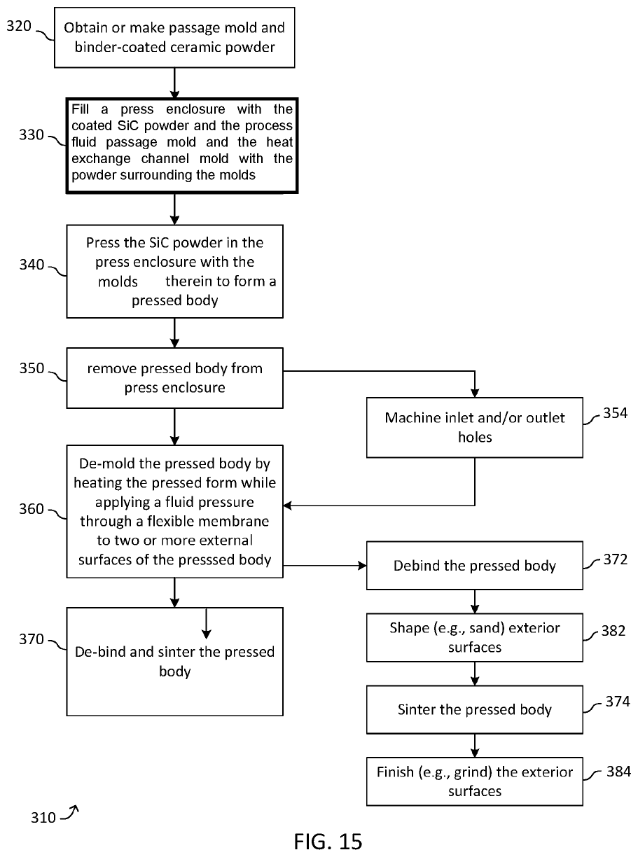

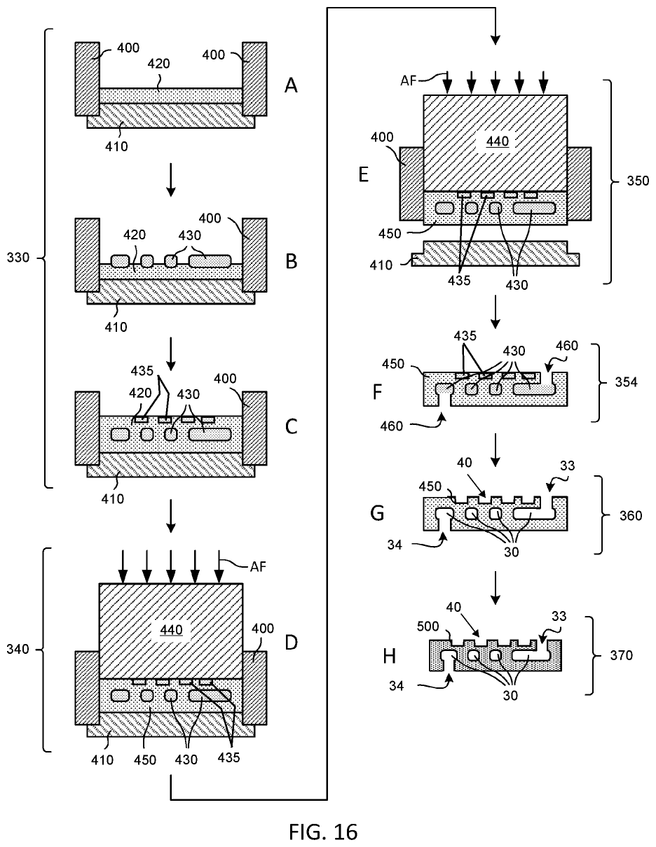

With reference to FIGS. 15 and 16, according to embodiments, a process 310 for forming a ceramic structure, such as a silicon carbide ceramic structure, having one or more of these or other desirable properties can include the step 320 of obtaining or making a process fluid passage mold, a heat exchange channel mold, and a binder-coated ceramic powder (such powders are commercially available from various suppliers). The process fluid passage mold and the heat exchange channel mold may be obtained by molding, machining, 3D printing, or other suitable forming techniques or combinations thereof. The material of the passage mold is desirably a relatively incompressible material. The material of the passage mold can be a thermoplastic material.

The process further can include the step of (partially) filling a press enclosure (or die) 400, the press enclosure 400 being closed with a plug 410, with binder-coated ceramic powder 420, as described in step 330 of FIG. 15 and as represented in the cross section of FIG. 16A. Next, the process fluid passage mold 430 is placed on/in the ceramic powder 420 (FIG. 16B) and an additional amount of powder is put on top of the process fluid passage mold 430. The heat exchange channel mold 435 is placed on/in the ceramic powder 420, and additional ceramic powder 420 is put around the heat exchange channel mold 435, such that the powder 420 surrounds the process fluid passage mold 430 and the bottom and sidewall surfaces of the heat exchange channel mold 435 (FIG. 16C, step 330 of FIG. 15). While the process fluid passage mold 430 is depicted as being placed in the press enclosure 400 after process fluid passage mold 430, in other embodiments, the heat exchange channel mold 435 may be placed on the plug 410 prior to initial filling of the die 400 with ceramic powder 420. Advantageously, this configuration ensures that the portion of the heat exchange channel mold 435 adjacent to the surface of the plug 410 will be exposed after the body is pressed. Further, positioning of the heat exchange channel mold 435 in the press enclosure 400 may be easier when it is inserted first.

Next, a piston or ram 440 is inserted in the press enclosure 400 and a force AF is applied to press (compress) the powder 420 with the molds 430, 435 inside (FIG. 16D and FIG. 15 step 340) to form a pressed body 450. (Resistance to the force AF (not shown) is present or supplied at the plug 410 during this step.) Next, with plug 410 now allowed to move, the pressed body 450 is removed by a (smaller) force AF applied to the piston 440 (FIG. 16E, step 350 of FIG. 15).

Next, the pressed body 450, now free from the press enclosure 400, is machined in selected locations, such as by drilling, to form holes or fluidic ports 460 (i.e., entrance port(s) 33 and exit port 34) extending from the outside of the pressed body 450 to the process fluid passage mold 430 (FIG. 16F, step 354 of FIG. 15). At this time, other features, such as the alignment holes 22, alignment slot 23, O-ring gland 35, etc., may also be formed into the pressed body 450.

Next, the pressed body 450 is demolded by being heated, preferably at a relatively high rate, such that the process fluid passage mold 430 and the heat exchange channel mold 435 is melted and removed from the pressed body 450 by flowing out of the pressed body 450, and/or by being blown and/or sucked out in addition. (FIG. 16G, step 360 of FIG. 15). The heating may be under partial vacuum, if desired. The heating is performed while applying a fluid pressure through a flexible membrane to two or more external surfaces of the pressed body 450. Because the process fluid passage 30 and the heat exchange fluid channel 40 are negative or void spaces, the molds 430, 435 used to form these features are also referred to herein and in the claims as “positive molds.”

After the positive molds 430, 435 has been melted and removed from the internal cavities or channels in the pressed body 450, the pressed body 450 is then fired (sintered) to densify and further solidify the pressed body into a monolithic silicon carbide body 500. (FIG. 16H, step 370 of FIG. 15).

As shown in the flowchart of FIG. 15, some additional or alternative steps can include step 372, debinding the pressed body prior to sintering (rather than as a unified step, or also rather than as two back-to-back steps), step 382, shaping or preliminarily shaping the exterior surface(s), such as by sanding or other machining before sintering, step 374, sintering the pressed body separately from debinding (and after step 382 shaping or preliminarily shaping), and step 384, finishing the exterior surface(s), such as by grinding, after sintering.

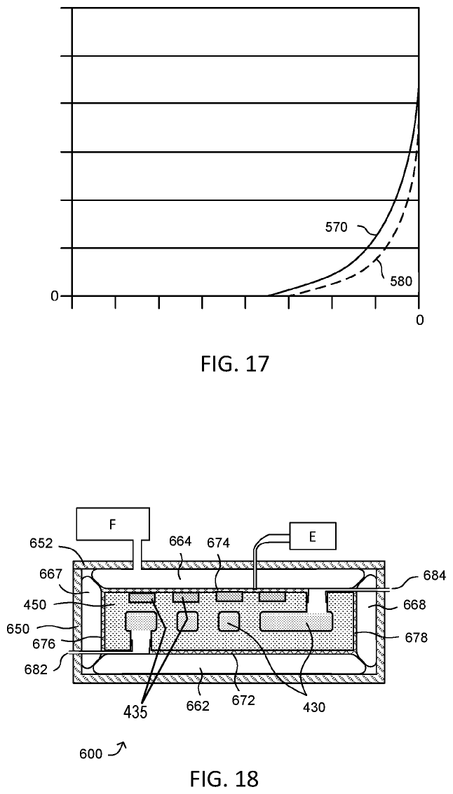

FIG. 17 is a graph illustrating compression release curves useful in practicing the methods of the present disclosure, in particular, showing a desirable relationship between the compression release property of the ceramic powder 420 and the material of the process fluid passage mold 430 and the heat exchange channel mold 435. Specifically, a compression release curve 570 of the ceramic powder material, graphed in units of distance (x axis) vs force (y axis) (arbitrary units shown) (time evolution is downward and leftward) should preferably lie above a compression release curve 580 of the material of the positive molds 430, 435. The respective compression curves, not shown, are not particularly significant. But using a relatively incompressible mold material, such that the ceramic powder compression release curve 570 lies above the mold material compression release curve 580 helps maintain the structural integrity of the pressed body during release of the pressed body from the press enclosure and during other steps subsequent to pressing. Further, to achieve the smooth internal passage walls, ceramic powder with generally smaller particle sizes is preferred, as are passage mold materials having generally higher hardness.

FIG. 18 shows in a cross-sectional representation an embodiment of an apparatus 600 for performing the demolding step 360 of FIG. 15. The apparatus 600 comprises an openable and closeable frame 650, such as with a lid 652 or other means of opening and closing, and with an interior and exterior. One or more flexible membranes 662, 664, 667, 668 are positioned within the frame 650 and have a first surface facing the interior of the frame 650 and a second surface (directly) opposite the first surface, the second surface forming at least part of an enclosed volume having fluid lines, connections, ports, or the like, connected or to be connected to a supply of pressurized fluid F. The apparatus 600 also includes a clearance or a pathway or a port or conduit 682, 684 or the like through which the material of a molds 430, 435 can drain when melted from a green state powder pressed ceramic body 450 while a pressure is applied to the green state powder pressed ceramic body 450 by a fluid, through the one or more flexible membranes 662, 664, 667, 668. The fluid supplied by fluid source F can be, according to embodiments, a heated liquid which supplies energy to the mold material by heating the green state powder pressed ceramic body 450.

In alternative embodiments, the fluid source F may be supplied gas under pressure such as compressed air or nitrogen, and the apparatus 600 can also include one or more flexible heating pads 672, 674, 676, 678 positioned on the first surface of the one or more flexible membranes 662, 664, 667, 668. A flexible heating pad of the apparatus can comprise (1) multiple zones in which input energy can be individually controlled and/or (2) multiple individually energizeable smaller heating pads, not shown, to which energy can be supplied by a source E of electrical energy.

In operation, in the apparatus of FIG. 18 or similar embodiments, energy is applied to the internal positive molds 430, 435 within the green state powder pressed ceramic body 450 to melt a material of the internal mold while a fluid pressure is applied through one or more flexible membranes to at least two opposite external surfaces (to the two largest surfaces) of the green state powder pressed ceramic body 450, while one or more of (1) allowing the melted mold material to drain from green state powder pressed ceramic body, (2) blowing the melted mold material from green state powder pressed ceramic body, and (3) sucking the melted mold material from green state powder pressed ceramic body to remove the mold. Energy can be applied to the internal mold by heating the mold by heating the green state powder pressed ceramic body. If pressure is applied to every side of the green state powder pressed ceramic body, such as by having individual flexible membranes on every side, pressure that is essentially isostatic may be applied.

According to additional aspects of the present invention, the flexible membrane through which pressure is applied may take the form of a fluid-tight bag enclosing the green state powder pressed ceramic body.

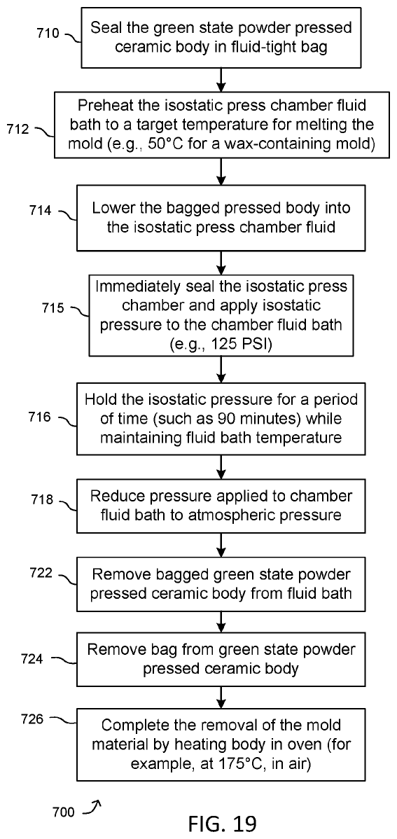

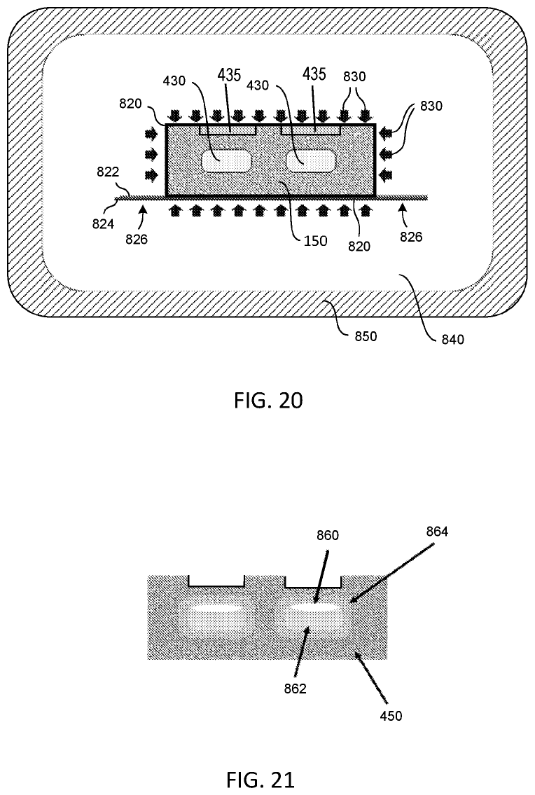

Process steps for one embodiment of demolding green pressed fluidic modules according to this aspect are shown in the flow chart of FIG. 19, and a cross-sectional representation of an apparatus for use in performing the process is shown in FIG. 20. With reference to both figures, the process 700 includes step 710 of sealing a green state powder pressed ceramic body 450, with the process fluid passage mold 430 and heat exchange channel mold 435 inside, in fluid-tight bag 820. As seen in FIG. 20, the bag 820 can include a top layer 822 and a bottom layer 824 sealed together at a seal region 826, such as by pinching together and heating top and bottom layers 822, 824 formed of polymer. Multiple rows of thermally produced seals can be used in the seal region 826 if desired. Vacuum sealing can be used and is preferred but not required, as successful tests have been performed on other green body structures with and without vacuum sealing. The bag is fluid-tight to the fluid 840 in the chamber 850, for example, water.

Further in FIG. 20, a press chamber 850 holds a fluid which is, in step 712 of the process 700, preheated to a target temperature for melting the molds (for example, to 50° C. for a wax-based molds). In step 714 the bag 820 with the green state powder pressed ceramic body 450 sealed inside is then lowered into the isostatic press chamber fluid 840. Next in step 715, the isostatic press chamber is immediately closed and sealed pressure is applied to the chamber fluid bath (e.g., 125 PSI), producing essentially isostatic pressure on all surfaces of the body 450. In step 716, the pressure and temperature are maintained for a period of time, such as 90 minutes, to melt the material of the process fluid passage mold 430 and the heat exchange channel mold 435.

The molds can be a wax-based material. As the green state powder pressed ceramic body 450 is heated by the warm fluid, the positive molds 430, 435 are also heated, and the mold material begins expanding, softening, and melting. The expansion produces an outward force on the interior walls of the passages within the body 450. The outward force is counteracted and/or balanced, at least in part, by the isostatic pressing force, represented by the arrows 830, applied to the exterior surface of the body 450 through the bag 820.

The melted mold material can move into ports, or into vents or other passages, not shown in FIG. 8, specifically provided therefor. As the mold material continues to heat, its viscosity can be reduced so that it can flow into the small gaps between powder granules of the body 450 in the region around the internal passage(s).

After the time period of step 716 is ended, the pressure inside the chamber 850 is reduced to atmospheric pressure in step 718, the chamber is opened and the bag 820 and body 450 are removed in step 722, and the bag 820 is removed from the body 450 in step 724. During steps 722 and 724, the body is preferably kept sufficiently warm (for example, at 50° C. or greater) to prevent re-solidification of the mold material, until any remaining mold material is completely removed by heating the body 450 in an oven (for example, at 175° C., in air), in step 726.

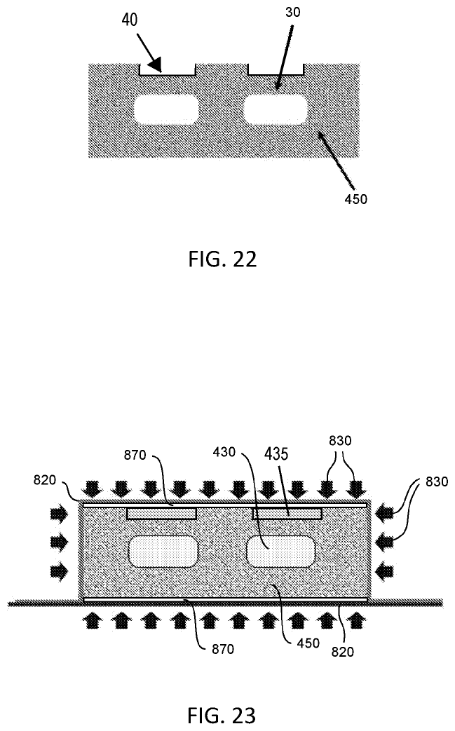

Prior to heating the body 450 in an oven in step 726, the body and the mold material may be in a state general depicted in the cross section of FIG. 20. As shown in FIG. 21, voids 860 may appear due to migration of mold material into ports or vents (not shown) and/or into a region 864 of the body 450 surrounding the internal passages. After the heating of step 726, the molds 430, 435 have been completely removed from the passages and from the body 450, as shown in the cross section of FIG. 22.

According to another and alternative aspect of the present disclosure shown in the cross section of FIG. 23, force-distribution plates 870 may be positioned between the body 450 and the bag 820. These plates 870, in the form of flexible metal or polymer sheets, for example, 870 can distribute the localized forces of the isostatic pressure across a wider area of the body 450 to prevent any tendency of that pressure to collapse the internal fluid passage(s) as the material of the mold(s) 430 melts. Such plates can be useful, in particular, on surfaces of the body which lie parallel to the larger dimension of the passage(s) 430, as shown in FIG. 23.

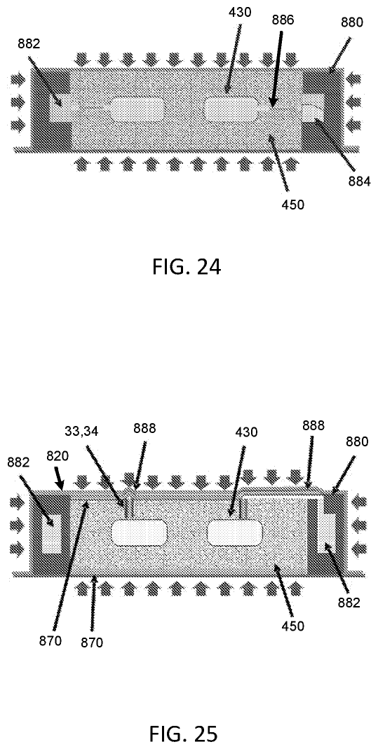

The cross section of FIG. 24 depicts additional or alternative features which can be used to assist with removal of melted mold material. Only the positive mold 430 of the process fluid passage 30, which enclosed within the press body 450, is depicted in this and the following figures for simplicity sake. The positive mold 435 of the heat exchange channel 40 is on the surface of the press body 450, and the wax of the heat exchange channel mold 435 is easier to drain during heating. As seen in FIG. 24, one or more reservoir frames 880 may be placed against one or more outer surfaces of the body 450. Reservoir frames 880 include a relatively large surface area in contact with the body 450 and reservoirs 882 within the reservoir frames 880. One or more ports or vents 886 for outflow of mold material lead from the internal passage molds 430 to the reservoirs 882. The surface area at which reservoir frames 880 contact the body 450 transfers pressure to the body 450, while the reservoirs 882 receive melted mold material 884 as the mold material softens and flows.

In another additional or alternative aspect, as an alternative to the one or more ports or vents 886, depicted in FIG. 25, one or more ridges 888 or “ridge channels” 888 (ridges which form a channel beneath the ridge) may be included one or more of the force distribution plates 870, to allow for flow of melted mold material along the ridge channel 888 to an associated reservoir frame 880. As shown in the figure, the reservoir frames 880 in this aspect can have full contact with the side of the body 450 against which they are positioned, with an opening into the reservoir on an adjoining face of the reservoir frame 880.

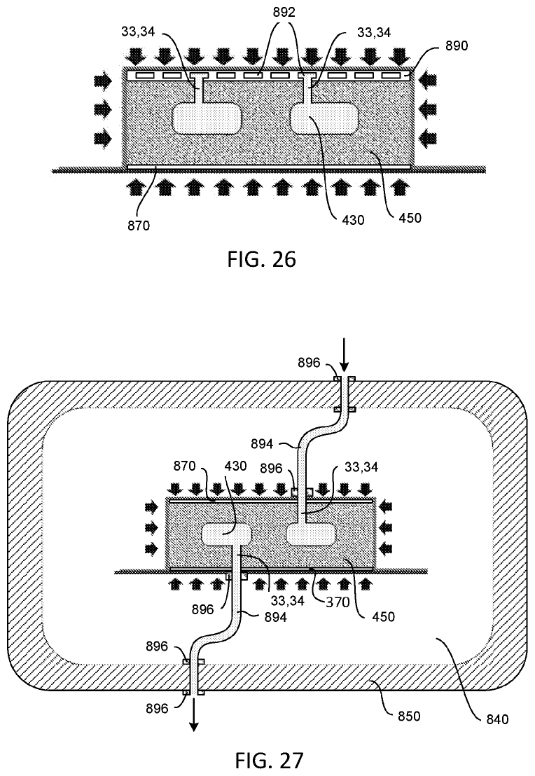

In yet another additional or alternative aspect shown in the cross section of FIG. 26, a force distribution plate 890 with cavities 892 can be employed on one or more surfaces of the body 450. The cavities 892 are interconnected (in a plane other than the cross-section shown) and entrance port 33 or exit port 34 are aligned with one or more of the cavities 892. Melted mold material from the passage mold(s) 430 can then flow into the cavities 892 as the mold material softens and flows.

In still another additional or alternative aspect shown in the cross section of FIG. 27, one or more tubes 894, can be used, joined at one end to the entrance ports 33 or exit ports 34 and extending out through the of the chamber 850, with seals 896 maintaining fluid tightness. In this aspect, pressure can be applied (as represented by the arrow at the top of the figure) or vacuum can be applied (as represented by the arrow at the bottom of the figure, or both to assist in the removal of melted mold material.

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

1. A flow reactor or flow reactor component comprising:
a base plate having top and bottom major surfaces opposite each other and of planar shape;
a first fluid module having first and second major surfaces of planar shape on opposite sides thereof and an edge surface extending between the first and second major surfaces, the first fluid module having a process fluid passage extending internally within the first fluid module from an entrance in the first major surface to an exit in the second major surface, the first fluid module also having a heat exchange channel in the first major surface, the first fluid module stacked on the base plate with the first major surface of the first fluid module stacked on the top major surface of the base plate;
a second fluid module having first and second major surfaces of planar shape on opposite sides thereof and an edge surface extending between the first and second major surfaces, the second fluid module having a process fluid passage extending internally within the second fluid module from an entrance in the first major surface to an exit in the second major surface, the second fluid module also having a heat exchange channel in the first major surface, the second fluid module stacked on the first fluid module with the first major surface of the second fluid module stacked on the second major surface of the first fluid module;
optional additional fluid modules of the same configuration as the first and second fluid modules stacked successively in like fashion on the second fluid module; and
a top plate having top and bottom major surfaces opposite each other and of planar shape, the top plate having a heat exchange channel in the bottom major surface, the top plate being stacked on an uppermost fluid module of (1) the second fluid module and (2) the optional additional fluid modules, with the bottom major surface of the top plate stacked on the second major surface of the uppermost fluid module.

2. The flow reactor or flow reactor component of claim 1 wherein the first and second fluid modules comprise ceramic.

3. The flow reactor or flow reactor component of claim 2 wherein the ceramic comprises silicon carbide.

4. The flow reactor or flow reactor component of claim 1 further comprising bolts joining the base plate and the top plate.

5. The flow reactor or flow reactor component of claim 4 further comprising springs mounted on the bolts and pushing together the fluid modules.

6. The flow reactor or flow reactor component of claim 1 further comprising tubing positioned within the heat exchange channel of the first fluid module, tubing positioned within the heat exchange channel of the second fluid module, and tubing positioned within the heat exchange channel of the top plate.

7. The flow reactor or flow reactor component of claim 1 further comprising a coating on the first major surface and a coating on the second major surface of the first fluid module and a coating on the first major surface and a coating on the second major surface of the second fluid module.

8. The flow reactor or flow reactor component of claim 1, wherein fluid communication is provided between the exit of the process fluid passage of the first fluid module and the entrance of the process fluid passage of the second fluid module and wherein an O-ring is disposed between the exit of the process fluid passage of the first fluid module and the entrance of the process fluid passage of the second fluid module.

9. The flow reactor or flow reactor component of claim 8, wherein a gland is formed in the second major surface around the exit of the process fluid passage of the first fluid module and wherein the O-ring is seated within the gland.

10. The flow reactor or flow reactor component of claim 8, wherein a gland is formed in the first major surface around the entrance of the process fluid passage of the second fluid module and wherein the O-ring is seated within the gland.

11. The flow reactor or flow reactor component of claim 8, wherein a gland is formed at least partially in the second major surface around the exit of the process fluid passage of the first fluid module and at least partially in the first major surface around the entrance of the process fluid passage of the second fluid module and wherein the O-ring is seated within the gland.

12. The flow reactor or flow reactor component of claim 8, further comprising a stem providing fluid communication between the exit of the process fluid passage of the first fluid module and the entrance of the process fluid passage of the second fluid module, wherein the O-ring is disposed around the stem.

13. The flow reactor or flow reactor component of claim 8, further comprising an O-ring frame and a spacer pin, wherein the O-ring frame is disposed around the exit of the process fluid passage of the first fluid module, wherein the O-ring is seated within the frame, wherein the spacer pin is inserted into a spacer pin hole formed in the second major surface of the first fluid module, and wherein the O-ring frame and the spacer pin maintain the second fluid module substantially parallel to the first fluid module.

14. A flow reactor or flow reactor component comprising:
a base plate having top and bottom major surfaces opposite each other and of planar shape;
a first fluid module having first and second major surfaces of planar shape on opposite sides thereof and an edge surface extending between the first and second major surfaces, the first fluid module having a process fluid passage extending internally within the first fluid module from an entrance in the first major surface to an exit in the second major surface, the first fluid module also having a recess in the first major surface, the recess containing a tube carrier structure with channels, the channels containing a tube, the channels facing into the recess in the first major surface, the first fluid module stacked on the base plate with the first major surface of the first fluid module stacked on the top major surface of the base plate;
a second fluid module having first and second major surfaces of planar shape on opposite sides thereof and an edge surface extending between the first and second major surfaces, the second fluid module having a process fluid passage extending internally within the first fluid module from an entrance in the first major surface to an exit in the second major surface, the second fluid module also having a recess in the first major surface, the recess containing a tube carrier structure with channels, the channels containing a tube, the channels facing into the recess in the first major surface, the first major surface of the second fluid module stacked on the second major surface of the first fluid module;
optional additional fluid modules of the same configuration as the first and second fluid modules stacked successively in like fashion on the second fluid module; and
a top plate having top and bottom major surfaces opposite each other and of planar shape, the top plate having either (1) a heat exchange channel in the bottom major surface, or (2) a recess in the bottom major surface, the recess containing a tube carrier structure with channels, the channels containing a tube, the channels facing out of the recess in the bottom major surface, the top plate being stacked on an uppermost fluid module of (1) the second fluid module and (2) the optional additional fluid modules with the bottom major surface of the top plate stacked on the second major surface of the uppermost fluid module.

15. The flow reactor or flow reactor component of claim 14, wherein the first and second fluid modules comprise ceramic.

16. (canceled)

17. The flow reactor or flow reactor component of claim 14 further comprising bolts joining the base plate and the top plate and springs mounted on the bolts and pushing together the fluid modules.

18. (canceled)

19. The flow reactor or flow reactor component of claim 14 further comprising a coating on the first major surface and a coating on the second major surface of the first fluid module and a coating on the first major surface and a coating on the second major surface of the second fluid module.

20. A process for forming a silicon carbide fluid module for a flow reactor, the process comprising:
positioning a first positive mold of a heat exchange channel and a second positive mold of a process fluid passage within a volume of binder-coated silicon carbide powder such that an exposed surface of the first positive mold is substantially co-planar with a first major surface of the volume of the binder-coated silicon carbide powder and such that the second positive mold is contained entirely within the volume of binder-coated silicon carbide powder;
pressing the volume of binder-coated silicon carbide powder with the first and second positive molds disposed therein to form a pressed body;
heating the pressed body to remove the first and second positive molds; and
sintering the pressed body to form a monolithic silicon carbide fluid module having a heat exchange channel formed on the first major surface and a process fluid passage formed on an interior of the monolithic silicon carbide fluid module.

21. The process of claim 20, further comprising the step of machining an entrance port and an exit port into the pressed body, the entrance port and the exit port extending to the second positive mold.

22. The process of claim 21, further comprising the step of forming at least one of an alignment hole, an alignment slot, or an O-ring gland into the pressed body prior to heating and sintering.
